(19) United States
(12) Patent Application Publication
(10) Pub. No.: US 2015/0059590 A1
(43) Pub. Date: Mar. 5, 2015

(54) Device for Expelling used Capsules of a Capsule Coffee Machine

(71) Applicant: Tsann Kuen (Zhangzhou) Enterprise Co., Ltd., Zhang Zhou (CN)

(72) Inventors: Zhiqiang Xue, Zhang Zhou (CN); Ying-I Su, Taipei City (TW); Yang-Chang Huang, Yilan City (TW); Yanming Zheng, Zhang Zhou (CN)

(21) Appl. No.: 14/473,512

(22) Filed: Aug. 29, 2014

(30) Foreign Application Priority Data
Aug. 30, 2013 (CN) 201320537996.0

(51) Int. Cl. A47J 31/40

(52) U.S. Cl. CPC A47J 31/407
USPC 99/295

(57) ABSTRACT

A device for expelling used capsules of a capsule coffee machine includes a support unit, a receiving seat and a linkage control unit, the support unit has a lower support and an upper support pivotally connected together; the receiving seat is pivotally connected to the lower support of the support unit for receiving a coffee capsule; and the linkage control unit with a pull plate is connected to the upper support and a switch plate pivotally connected to the lower support of the support unit; when the upper support swings upwardly, the pull plates moves upwardly and pulls up the switch plate and the switch plate raises the receiving seat from a receiving position to an overturning position. With the linkage control unit, when the upper support swings it drives the receiving seat with a coffee capsule to expel the coffee capsule out of the receiving seat automatically.

### CROSS-REFERENCE TO RELATED APPLICATION

This application claims the benefit of priority to CN 201320537996.0, filed with the State Intellectual Property Office of the People's Republic of China on Aug. 30, 2013, the entire specification of which is hereby incorporated by reference.

### FIELD OF THE INVENTION

The present invention relates to a capsule coffee machine, especially to a device for expelling used capsules of a capsule coffee machine that can receive a coffee capsule and expel the coffee capsule after used.

### BACKGROUND OF THE INVENTION

We use a coffee grinder to grind coffee beans into powder to make coffee drink, then use a coffee machine to brew and filter. To make the coffee drink easier and more stable in taste, there are capsule coffee machines, firstly mixing the coffee beans to coffee material with stable taste, and then sealing up the coffee material in a capsule, this kind of capsule with coffee material is called coffee capsule. When brewing coffee, the drink-making process involves using a pricker to puncture the coffee capsule, so that hot water flows into the coffee capsule, then using another pricker to puncture the coffee capsule to make the brewed coffee drink flowing out.

However, to brew the coffee capsule, it needs hot water, so that it's usually in high temperature around the coffee capsule of the capsule coffee machine, thus people can not casually take or put the coffee capsules, they need special tool to do that, causing it inconvenient, and dangerous to take or put the coffee capsules.

### SUMMARY OF THE INVENTION

The object of the present invention is to provide with a device for expelling used capsules of a capsule coffee machine with simple, quick and safe operation.

The device for expelling used capsules of a capsule coffee machine is used for receiving a coffee capsule, comprising a support unit, a receiving seat and a linkage control unit, the support unit has a lower support and an upper support pivotally connected to the lower support; the receiving seat is pivotally connected to the lower support of the support unit for receiving a coffee capsule; and the linkage control unit with a pull plate is connected to the upper support and a switch plate pivotally connected to the lower support of the support unit; when the upper support swings upwardly, the pull plates moves upwardly and pulls up the switch plate and the switch plate raises the receiving seat from a receiving position to an overturning position.

The advantages of the present invention is that: with the linkage of the linkage control unit, when the upper support swings, it drives the receiving seat with a coffee capsule to overturn to expel the coffee capsule out of the receiving seat automatically, the present invention has simple, quick and safe operation.

### BRIEF DESCRIPTION OF THE DRAWINGS

FIG. 1 illustrates a side view of an embodiment of the present invention when a receiving seat of the device for expelling used capsules is in a receiving position.

FIG. 2 illustrates a partial exploded and schematic diagram of this embodiment to describe the relationship of a lower support, a linkage control unit and the receiving seat of the automatic expel mechanism when the receiving seat is in an overturning position.

FIG. 3 illustrates an incomplete schematic diagram of this embodiment to describe the relationship of the linkage control unit, the lower support and the receiving seat.

FIG. 4 illustrates a side view of this embodiment like FIG. 1 when an upper support of device for expelling used capsules swings down.

FIG. 5 illustrates an incomplete side diagram of this embodiment to describe the relationship of the receiving seat and the linkage control unit when a pull element of the linkage control unit moves to the lower of a switch plate.

FIG. 6 illustrates an incomplete side diagram of this embodiment like FIG. 5 when the receiving seat is in overturning position.

FIG. 7 illustrates another incomplete side diagram of this embodiment like FIG. 6 when the receiving seat is in overturning position.

### DETAILED DESCRIPTION OF THE EMBODIMENTS

The present invention will be further described with the drawings and the embodiment.

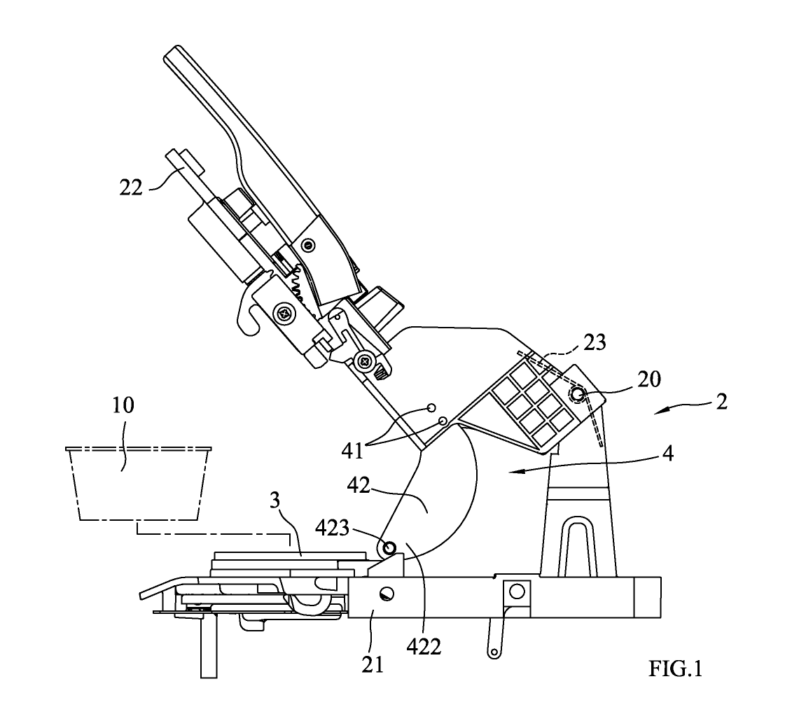

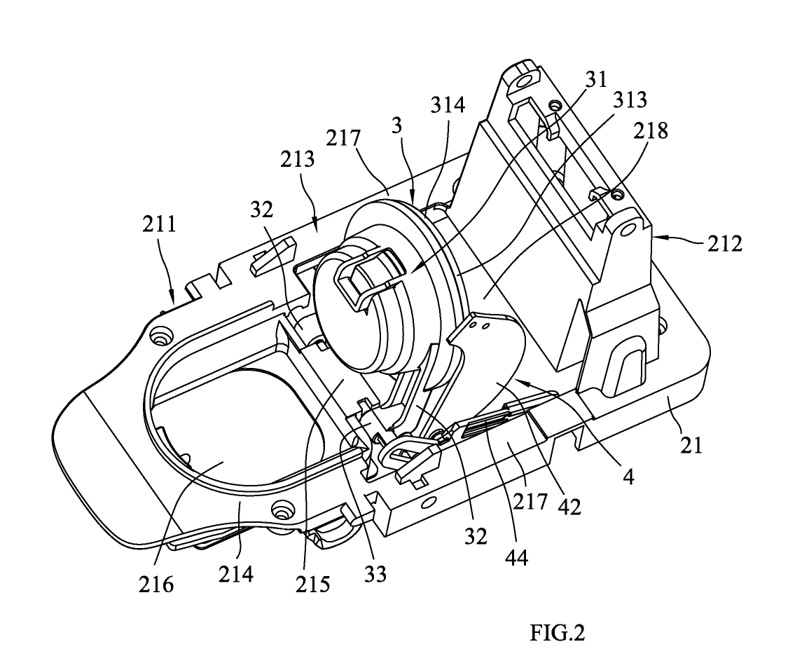

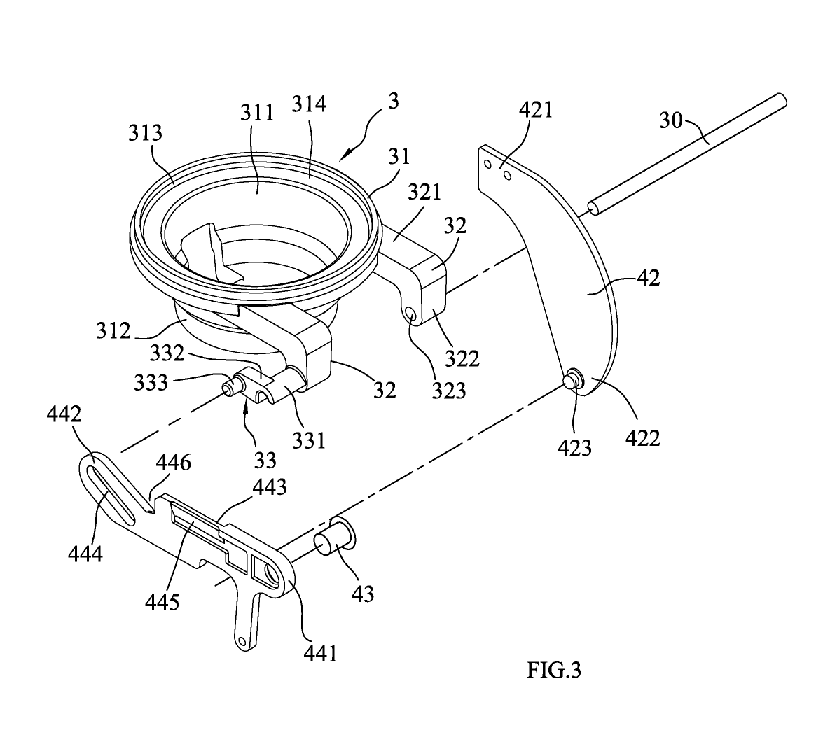

Please refer to FIG. 1, FIG. 2, FIG. 3, a device for expelling used capsules of the present invention is to assemble to the interior of a capsule coffee machine, the device can receive a coffee capsule 10 with coffee material, with a puncture mechanism in the coffee machine (not shown), people can brew the coffee material, as the improvement of the present invention is nothing to do with how to brew the coffee material, how to brew is not described here. The device for expelling used capsules comprises: a support unit 2, a receiving seat 3 pivotally connected to the support unit 2 by a first pivot shaft 30, and a linkage control unit 4 connected to the support unit 2 to drive the receiving seat 3 to change between a receiving position and an overturning position, the coffee capsule 10 is received in the receiving seat 3, the linkage control unit 4, when the support unit 2 swings, drives the receiving seat 3 to change between the receiving position and the overturning position.

The support unit 2 comprises a lower support 21 and an upper support 22 pivotally connected to the lower support 21 by a second pivot shaft 20, and a torsion spring 23 for enabling the upper support 22 to swing around the second pivot shaft 20 upwardly and backwardly, the lower support 21 comprises a lower frame portion 211 for assembling the receiving seat 3 in the front, a lower pivot portion 212 for assembling the upper support 22 at the rear protruded upwardly for the first pivot shaft 20 to run through, and an expel portion 213 located between the lower frame portion 211 and the lower pivot portion 212. The lower frame portion 211 comprises a baffle 214 surrounding the front and the two sides, a shaft block 215 connected at the rear of the baffle 214 laterally, and an accommodating room 216 defined by the baffle 214 and the shaft block 215, the expel portion 213 comprises two parallel side walls 217 opposing each other, and an expel through hole 218 located between the side walls 217, the expel through hole 218 is bigger than the coffee capsule 10. The upper support 22 has an upper frame portion 221, and an upper pivot portion 222 pivot joint to the lower pivot portion 212 of the lower support 21, the upper pivot portion 222 comprises two parallel left and right side flaps 223. The torsion spring 23 sleeves on the second pivot shaft 20.

The receiving seat 3 comprises a receiving portion 31 for receiving the coffee capsule, two parallel fulcrum bars 32 extending away from the receiving portion 31, and a swing controlled portion 33 protruding outwardly from one fulcrum bar 32, the fulcrum bars 32 are respectively disposed at the opposite sides of the shaft block 215 of the lower support 21. The receiving portion 31 comprises a round wall 312 to hold the receiving room 311 of the coffee capsule 10, the round wall 312 comprises an edge 313 near the upper to mount on the baffle 214 of the lower support 21, the receiving room 311 has an opening 314, the opening 314 faces upwardly when in receiving position, each of the fulcrum bars 32 comprises a rear projection section 321 extending backwardly horizontally, a pendant section 322 extending downwardly from the rear projection section 321, and a pivot hole 323 disposed in the pendant section 322 near to the bottom edge, the first pivot shaft 30 connects the pivot hole 323 of the fulcrum bar and the shaft block 215 of the lower support 21, so that the receiving seat 3 can swing upwardly and backwardly around the first pivot shaft 30. The swing controlled portion 33 comprises a side projection piece 331 partially surrounding the axes of the first pivot shaft 30 and protrudes out from the pendant section 322 of one fulcrum bar 32, a front projection block 332 extending away from the side projection piece 331, and a control bar 333 connected to a side of the front projection block 332 and extends away from the front projection block 332 near the front edge, that is to say, the control bar 333 protrudes from one of the side walls 217 of the lower support and near to said side wall 217.

The linkage control unit 4 of this embodiment is disposed with a pull plate 42 connected to the interior of one of the side flaps 223 of the upper support 22 by a plurality of first fixation elements 41, and a switch plate 44 pivotally connected to the interior of one of the side walls 217 of the lower support 21 by a second fixation element 43. The pull plate 42 is disposed with a fixation end 421 fixed to said side flap 223, a pull end 422 spaced with the fixation end 421 extending to the switch plate 44, and a pull element 423 connected to the pull end 422 and protruding to the switch plate 44. The switch plate 44 comprises a fulcrum portion 441 in one end of the switch plate 44 for the second fixation element 43 to run through, a control hole 442 in an opposite end of the switch plate 44 disposed spaced in the front of the fulcrum portion 441, and a lift portion 443 located between the fulcrum portion 441 and the control portion 442, the control portion 442 has an elongated control hole 444 extending forwardly and backwardly, the control bar 333 of the receiving seat 3 is inserted into and slides inside the elongated control hole 444. The lift portion 443 has a hook wall 445 protruding inwardly with an inclined surface faced inwardly, and a groove 446 between the hook wall 445 and the control portion 442, the pull element 423 of the pull plate 42 can move to the hook wall 445 of the switch plate 44 and then abut against on the lower of the hook wall 445 to lift the switch plate 44, when the switch plate 44 is lifted, it swings around the second fixation element 43.

When the receiving seat 3 of this embodiment is in the receiving position as figured in FIG. 1, the upper support 22 swings upwardly and backwardly under the work of the torsion spring 23, meanwhile, the coffee capsule 10 is placed inside the receiving room 311 of the receiving seat 3. In this position, the pull element 423 of the pull plate 42 is approximately in the front up of the hook wall 445 of the switch plate 44.

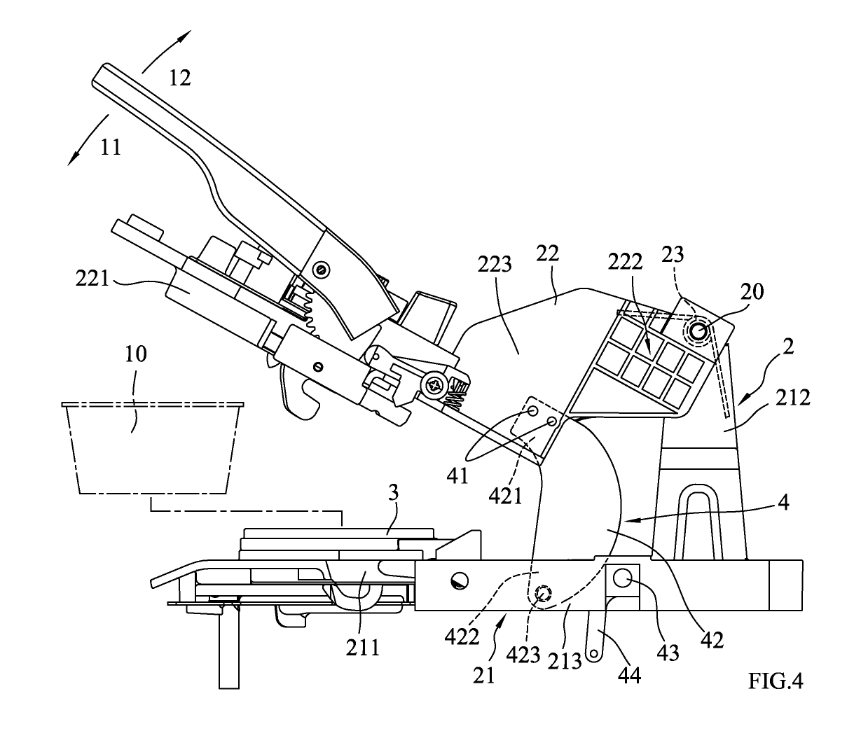

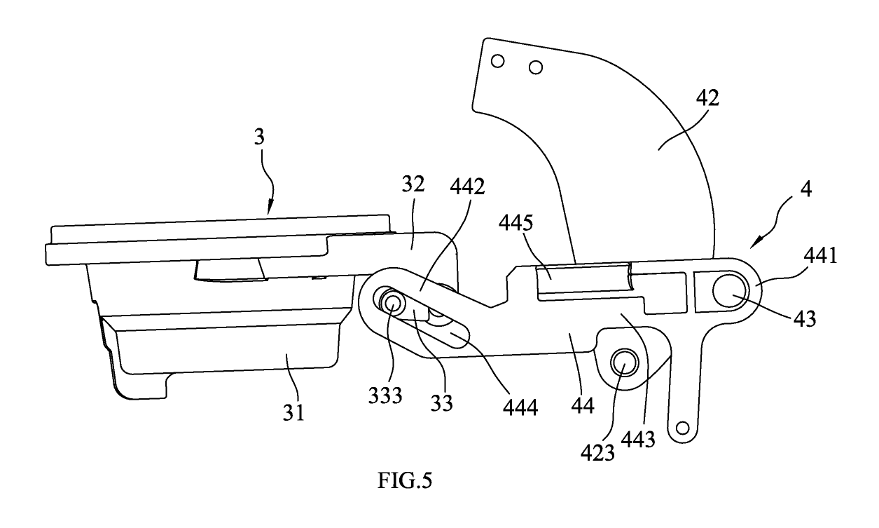

Refer to FIG. 1, FIG. 4 and FIG. 5, the user operates to overcome the elastic force of the torsion spring 23, then pressing the upper support 22 to the lower support 21 toward a brew direction 11, the puncture mechanism in the support unit 2 (not shown) punctures the coffee capsule 10 to brew coffee. As the improvement of the present invention is nothing to do with how to brew the coffee material, how to brew is not described here. During brewing, the pull plate 42 is driven to move down by the upper support 22, the pull element 423 of the pull plate 42 abuts against the inclined surface of the hook wall 415 of the switch plate 44 and then crosses by, and then moving to the back down of the switch plate, that is to say, the pull element 423 of the pull plate 42 moves to a standby position in FIG. 5 from the position in FIG. 4, at this time, the pull element 423 is approximately in the back down of the switch plate 44.

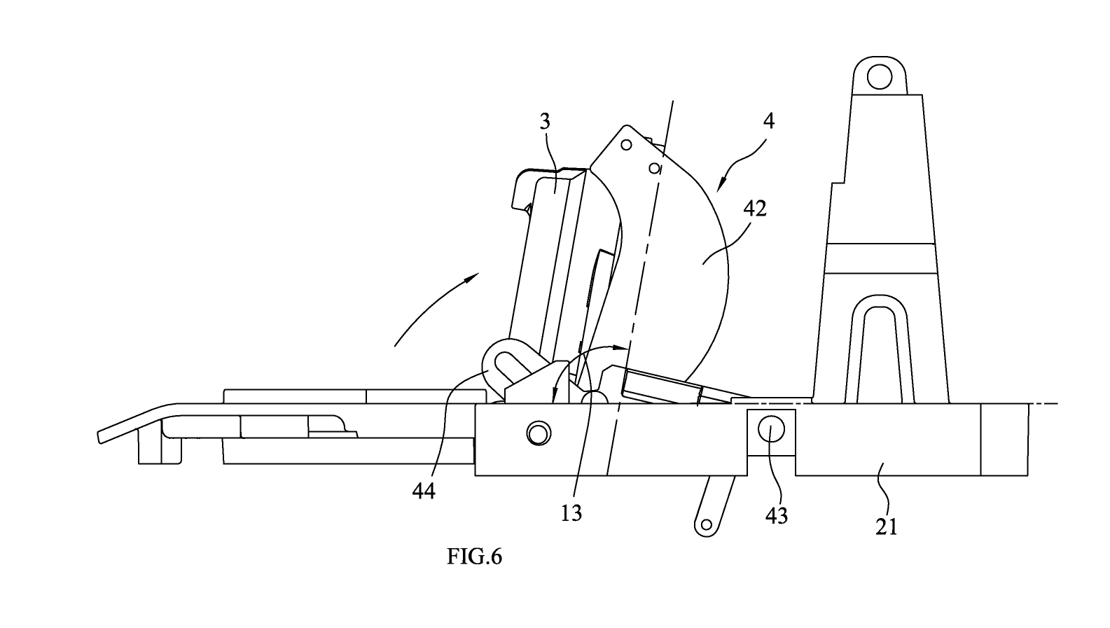

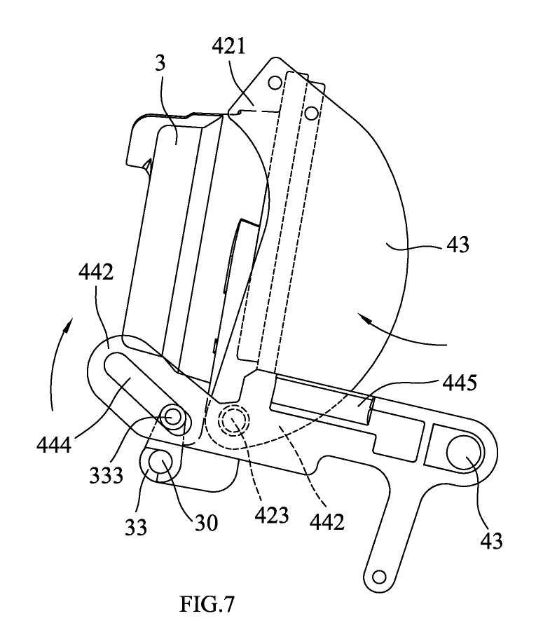

Please refer to FIG. 1, FIG. 3, FIG. 6 and FIG. 7, after the coffee capsule 10 is brewed, under the work of the torsion spring 23, the upper support 22 swings upwardly and backwardly in an expel direction 12 opposite to the brew direction 11, meanwhile, the upper support 22 swinging backwardly drives the pull plate 42 to swing together, as the pull element 423 of the pull plate 42 is at the back down of the hook wall 445 of the switch plate 44, when the fixation end 421 of the pull plate 42 swings backwardly with the upper support 22, the pull end 422 of the pull plate 42 and the pull element 423 swing forwardly, and then abutting against on the lower edge of the switch plate 44, then lifting the switch plate 44 up gradually to swing around the second fixation element 43, as the control bar 333 of the swing controlled portion 33 of the receiving seat inserts into the control hole 444 of the control portion 442 of the switch plate 44, the lifting motion will drive the receiving seat 3 to swing backwardly around the first pivot shaft 30 as a fulcrum.

Please refer to FIG. 3, FIG. 6 and FIG. 7, when the pull element 423 of the pull plate 42 separates from the hook wall 445 of the switch plate 44, the receiving seat 3 and the lower support 21 form an overturning incline angle 13, in this embodiment, the overturning incline angle 13 is approximately 110 degrees, that is to say, when the receiving seat 3 changes to the overturning position form the receiving position, the opening 314 of the receiving room 311 of the receiving seat 3 is overturned and inclined to the expel through hole 218 of the lower support 21, so that the present invention expels the used coffee capsule 10 to the expel through hole 218 of the lower support, obtaining automatic expelling under a convenient and safe operation. Under the designation, the overturning incline angle 13 is larger than 90 degrees, there is no limitation to the angle of this embodiment.

1. A device for expelling used capsules of a capsule coffee machine, comprising:
a support unit having a lower support, and an upper support pivotally connected to the lower support;
a receiving seat pivotally connected to the lower support of the support unit, for receiving a coffee capsule; and
a linkage control unit with a pull plate connected to the upper support and a switch plate pivotally connected to the lower support of the support unit;
wherein when the upper support swings upwardly, the pull plates moves upwardly and pulls up the switch plate and the switch plate raises the receiving seat from a receiving position to an overturning position.

2. The device of claim 1, wherein
the switch plate comprises a fulcrum portion in one end of the switch plate, a control portion in an opposite end of the switch plate, and a lift portion located between the fulcrum portion and the control portion,
the pull plate comprises a fixation end connected to the upper support, a pull end extended to the lower support and a pull element connected to the pull end,
the receiving seat pivotally connects to the lower support by a first pivot shaft, the receiving seat comprises a receiving portion for receiving the coffee capsule, and a swing controlled portion engaging the control portion of the switch plate; when the upper support swings toward an expel direction, the pull element of the pull plate lifts the lift portion of the switch plate, and causes the switch plate to swing upwardly and to drive the receiving seat to the overturning position.

3. The device of claim 2, wherein the control portion of the switch plate comprises an elongated control hole, the swing controlled portion of the receiving seat is provided with a control bar, which is inserted into and slides inside the elongated control hole; when the upper support swings toward the expel direction, the control bar slides inside the elongated control hole of the switch plate as the receiving seat changes positions.

4. The device of claim 3, wherein the lift portion of the switch plate is disposed with a hook wall, the pull element of the pull plate, when the upper support swings toward the expel direction, lifts the hook wall to drive the switch plate to swing around the fulcrum portion.

5. The device of claim 4, wherein
the support unit further comprises a second pivot shaft for pivoting the upper support to the lower support, and a torsion spring for enabling the upper support to swing around the second pivot shaft,
the lower support comprises a lower frame portion for assembling the receiving seat, a lower pivot portion for assembling the upper support, and an expel portion located between the lower frame portion and the lower pivot portion, the expel portion defines an expel through hole for receiving the coffee capsule when the receiving seat is in the overturning position.

6. The device of claim 5, wherein
the expel portion of the lower support comprises two side walls opposing each other, and
the upper support comprises an upper frame portion matching to the lower frame portion of the lower support when the upper support swings up and down, and an upper pivot portion, the upper pivot portion comprises two side flaps spaced left and right, the linkage control unit further comprises at least one first fixation element for attaching the pull plate to one side flap and a second fixation element for pivotally connecting the switch plate to one side wall of the lower support, the pull plate and the switch plate are on a same side of the upper support.

7. The device of claim 5, wherein
the lower frame portion of the lower support comprises a baffle, a shaft block connected to the baffle and an accommodating room defined by the baffle and the shaft block,
the receiving seat further comprises two parallel fulcrum bars extending away from the receiving portion and each fulcrum bar connects to one end of the shaft block of the lower support,
the swing controlled portion protrudes from one fulcrum bar towardly the linkage control unit, and
the first pivot shaft connects both fulcrum bars to the shaft block.

8. The device of claim 7, wherein each of the fulcrum bars of the receiving seat is provided with a rear projection section extending to the expel portion of the lower support, and a pendant section extending downwardly from the rear projection section, the swing controlled portion extends from the pendant section of one fulcrum bar.

9. The device of claim 8, wherein the swing controlled portion of the receiving seat further comprises a side projection piece partially surrounding the first pivot shaft connected to one fulcrum bar, and a front projection block extending away from the side projection piece, the control bar is connected to a side of the front projection block and extends away from the front projection block.

10. The device of claim 8, wherein
the receiving portion of the receiving seat has a receiving room, the receiving room is disposed with an opening, when the receiving seat is in the receiving position, the opening of the receiving room faces upwardly, when the receiving seat is in the overturning position, the receiving seat and the lower support form an overturn incline angle, the opening of the receiving room of the receiving seat faces downwardly to the expel through hole of the lower support.

11. The device of claim 10, wherein the overturn incline angle is larger than 90 degrees.

12. The device of claim 1, wherein, when in overturning position, the receiving seat and the lower support form an overturn incline angle larger than 90 degrees.
